(19) United States
(12) Patent Application Publication
(10) Pub. No.: US 2005/0035953 A1
(43) Pub. Date: Feb. 17, 2005

(54) Single-layer touchpad and methods of use

(76) Inventors: Richard Woolley, Orem, UT (US); David Taylor, Salt Lake City, UT (US); Michael D. Layton, Salt lake City, UT (US); Brian Taylor, Sandy, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/871,546

(22) Filed: Jun. 18, 2004

Related U.S. Application Data
(60) Provisional application No. 60/480,360, filed on Jun. 20, 2003.

(51) Int. Cl. G09G 5/00

(52) U.S. Cl. 345/173

(57) ABSTRACT

A single-layer touchpad comprised of a relatively clear substrate, a first electrode disposed thereon, and a sense electrode disposed thereon, wherein the first electrode and the sense electrode are comprised of a conductive material, wherein the first electrode in combination with the sense electrode are used to detect the presence of a pointing object in a zone, or the simultaneous presence of multiple pointing objects in multiple zones, and wherein the first electrode and/or the sense electrode are made such that a pattern is visually detectable on the display screen.

### BACKGROUND OF THE INVENTION

1. Field of the Invention

This invention relates generally to touchpads. More specifically, the invention relates to a touchpad that can be disposed on a viewing screen such as a liquid crystal display (LCD), plasma display (PD), or a cathode-ray tube (CRT), wherein the viewing screen is used to view data stored on a stationary object such as a large television or a computer, or view data on a portable electronic appliance such as a small television, a portable computer, personal digital assistant (PDA), mobile telephone, digital camera, camcorder, a display for consumer appliances such as a microwave, over, stove, refrigerator, dishwasher, washing machine, dryer, and a stereo, wherein the touchpad is capable of determining which zone a user is touching.

2. Description of Related Art

The state of the art of touchpads is characterized by a touch-sensitive device operating on the principles of resistance, capacitance, optical or other means of sensing touch. It was determined that the sensing electrodes of a touchpad can be disposed on a clear substrate, where the electrodes are made from electrically conductive materials such as indium tin oxide (ITO).

The substrate can be rigid or flexible, but as a practical matter, the substrate should be relatively thin. Good materials for substrates that are relatively clear and through which a user can see a viewing or display screen include KAPTON®, MYLAR™, KADADEX®, polyethylene napthalate and other materials having similar mechanical and electrical properties.

Complete touchpad functionality is generally characterized as providing cursor control for a computer, television, or a portable electronic or consumer appliance. Accordingly, such a touchpad requires at least two layers of sensing electrodes when the touchpad uses capacitance sensing technology, such as that provided by CIRQUE CORPORATION. Multiple substrate layers and thus multiple or overlapping layers of electrodes generally results in a touchpad that is mostly transparent, but can be difficult to see through when disposed on top of a display.

Attempts have been made to make the substrate layers and the materials for the electrodes to be thinner and therefore to have greater transparency. The attempts so far have still resulted in a display screen that is uncomfortably dimmed by the touchpad.

Accordingly, what is needed is a touchpad that does not interfere with viewing a display screen, wherein at least a portion of the display screen can be touched to provide touchpad functionality.

When considering typical features of touchpads, it is necessary to include cursor control and scrolling capabilities. However, these features are not always required in the particular device with which the touchpad is being used.

For example, touch zone control is a feature wherein the touchpad sends data to the device indicating in what area the user has made contact. Thus, touch zones can function as buttons or keys. However, state of the art capacitance sensitive touchpads are only able to provide this type functionality when disposed on top of a display screen by using multiple layers of substrates and/or electrodes. The result is that the clarity of the display screen is generally compromised because of the touchpad. Accordingly, it would be another advantage to provide a touchpad that provides touch zone control to a user, wherein the touchpad provides better clarity when disposed on top of a display screen.

### BRIEF SUMMARY OF THE INVENTION

It is an object of the present invention to provide a touchpad that includes one signal electrode and a sense electrode on a single substrate, thereby improving display screen clarity by not using a second signal electrode.

It is another object to provide the one electrode in a plurality of different locations within the sensor area of the touchpad.

It is another object to provide the one electrode and the sense electrode on a generally transparent substrate.

It is another object to provide the single-layer touchpad wherein the touchpad is capable of detecting an object touching a zone of the touchpad.

It is another object to provide the single-layer touchpad wherein the touchpad is capable of simultaneously detecting the presence of multiple objects touching a plurality of zones of the touchpad.

It is another object to provide the single-layer touchpad wherein the electrodes of the touchpad are arranged in a desirable pattern, and wherein the desired pattern is at least partially visible.

In a preferred embodiment, the present invention is a single-layer touchpad comprised of a relatively clear substrate, a first electrode disposed thereon, and a sense electrode disposed thereon, wherein the first electrode and the sense electrode are comprised of a conductive material, wherein the first electrode in combination with the sense electrode are used to detect the presence of a pointing object in a zone, or the simultaneous presence of multiple pointing objects in multiple zones, and wherein the first electrode and/or the sense electrode are at least partially visible so that a pattern is visually detectable on the display screen.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a cross-sectional profile view of a first embodiment of the present invention.

FIG. 2 is a cross-sectional profile view of a second embodiment of the present invention.

FIG. 3 is a cross-sectional profile view of a third embodiment of the present invention.

FIG. 4 is a cross-sectional profile view of a fourth embodiment of the present invention.

FIG. 5 is a cross-sectional profile view of a fifth embodiment of the present invention.

FIG. 6 is a cross-sectional profile view of a sixth embodiment of the present invention.

FIG. 7 is a cross-sectional profile view of a seventh embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a single-layer substrate. On this single-layer substrate, only a single electrode (X or Y) and a single sense electrode are needed to detect touching in a zone. The single electrode and the sense electrode are coupled to a touchpad sensing circuit, such as the circuit sold by CIRQUE CORPORATION in its touchpads. The touchpad sensing circuit determines in which zone of a plurality of zones is being touched. The touch zones are defined by the single electrode and the sense electrode as explained in previously filed patent application Ser. No. 60/400,843, and is incorporated herein by reference.

An important aspect of the invention is the ability to make at least partially visible a desirable pattern as seen when looking at the display screen. Assuming that a single-layer touchpad has been disposed between the display screen and the user, or the touchpad is visible from the underside of the display screen, it may be desirable that the touchpad not be made completely transparent to the user.

For example, the electrodes of the touchpad can be made visible to the user by taking advantage of certain characteristics of the materials used in them. Consider a conductive material for the electrodes whose width, thickness, color content, and/or transparency can be varied in order to obtain various degrees of visibility. Thus, additional materials may be added to the conductive material used for the electrodes, wherein the additional materials darken or lighten the appearance of the conductive material, or even give the conductive material a color.

The purpose of increasing the opacity of the electrodes would seem to be contrary to the goal of making the presence of the touchpad electrodes unnoticeable. However, making the electrodes at least partially visible in at least one zone enables a seller of a device to make a desired image visible to users or buyers of a product. In other words, the seller can brand the device with an image, logo, or word so that there is no mistake as to the identity of the source of the product when a logo or other service or trademark is visually discernible to the user or buyer.

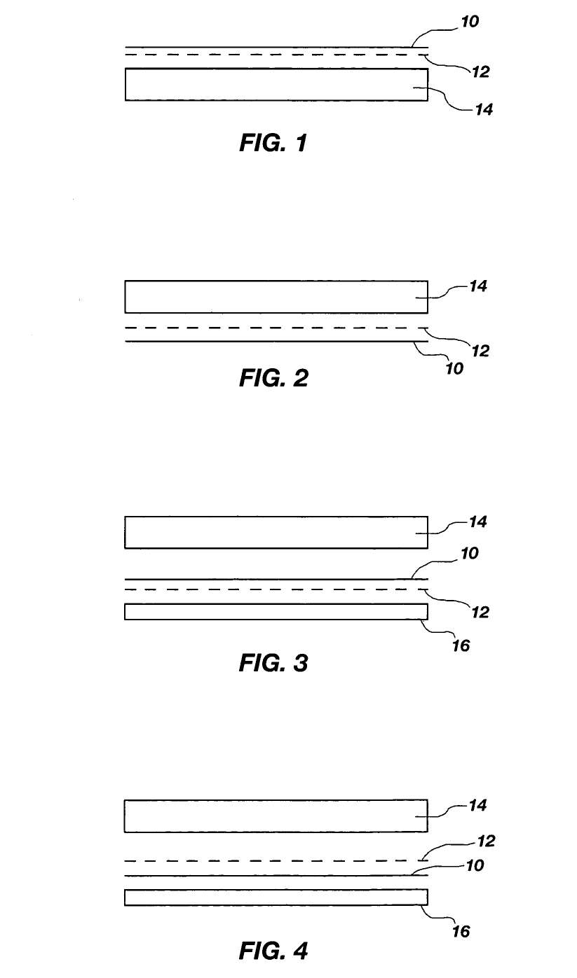

FIG. 1 is a cross-sectional profile view of a first embodiment of the present invention. The diagram illustrates the layering of materials in a device utilizing the touchpad of the present invention. The top layer is the substrate material 10 on which the electrodes 12 of the single-layer touchpad are disposed. Thus, the substrate material 10 is functioning as a material on which to dispose the electrodes 12, and as a protective barrier over the electrodes 12 to prevent damage to them. The next layer is glass or other cover material 14 used as a barrier that is disposed over the display screen (not shown) of the device.

FIG. 2 is a cross-sectional profile view of another embodiment of the present invention. In this diagram, the cover material 14 is shown as the top layer of the display screen in the device. The electrodes 12 are disposed on the substrate material 10 and against the cover material 14.

FIG. 3 is a cross-sectional profile view of another embodiment of the present invention. In this diagram, the cover material 14 is the top layer. The substrate material 12 is the next layer, and the electrodes 12 are disposed thereon. The bottom layer is a liquid crystal display (LCD) of the display screen of the device.

FIG. 4 is a cross-sectional profile view of another embodiment of the present invention. FIG. 4 differs from FIG. 3 only in that the orientation of the substrate material 10 and the electrodes 12 are reversed in order.

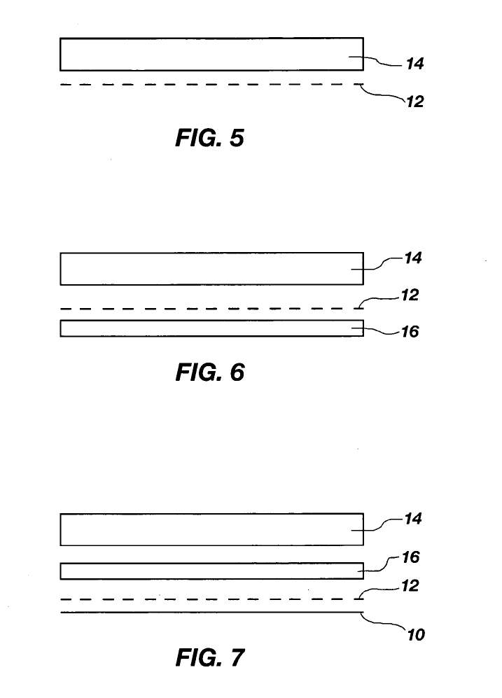

FIG. 5 is a cross-sectional profile view of another embodiment of the present invention. In this drawing, the cover material 14 is the top layer. The electrodes 12 are shown disposed directly to the underside of the cover material 14. Thus, the cover material 14 functions as protection for the display screen, and as the protection and a substrate for the electrodes of the touchpad.

FIG. 6 is a cross-sectional profile view of another embodiment of the present invention. In this drawing, the cover material 14 is the top layer. The electrodes 12 are underneath, and disposed on top of the LCD screen 16. Thus, the LCD functions as part of the display screen, and as the substrate for the electrodes 12.

FIG. 7 is a cross-sectional profile view of another embodiment of the present invention. In this drawing, the cover material 14 is shown as the top layer. The next layer is the LCD 16. The electrodes 12 and the substrate material 10 are next. The electrodes 12 and the substrate material 10 can be reversed in order.

It should be apparent that the present invention contemplates many different configurations for combining the single-layer touchpad of the present invention with a display screen of the present invention. These other variations should be considered to be within the scope of the present invention.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A single-layer touchpad for use with a display screen, said single-layer touchpad comprised of:
a single layer of substrate;
a first electrode disposed on a first side of the single layer of substrate;
a sense electrode disposed on the first side of the single layer substrate; and
a display screen, wherein the first side of the single layer of substrate is disposed against a top surface of the display screen such that the single layer of substrate is a protective barrier over the first electrode and the sense electrode.

2. The single-layer touchpad as defined in claim 1 wherein the first electrode is comprised of a conductive material that can be modified so as to be visually detectable.

3. The single-layer touchpad as defined in claim 2 wherein the sense electrode is comprised of a conductive material that can be modified so as to be visually detectable.

4. The single-layer touchpad as defined in claim 3 wherein the conductive material is modified to be visually detectable by modifying the width, thickness, color content, or transparency of the conductive material.

5. The single-layer touchpad as defined in claim 4 wherein the transparency of the conductive material is modified by adding material to the conductive object that increases opacity of the conductive material.

6. The single-layer touchpad as defined in claim 3 wherein the first electrode is disposed so as to form a desired pattern that is visually detectable when looking at the display screen.

7. The single-layer touchpad as defined in claim 6 wherein the sense electrode is disposed so as to form a desired pattern that is visually detectable when looking at the display screen.

8. The single-layer touchpad as defined in claim 7 wherein the desired pattern is selected from the group of desired patterns comprised of logos, visual designs, trademarks, service marks, and words.

9. A single-layer touchpad for use with a display screen, said single-layer touchpad comprised of:
a single layer of substrate;
a first electrode disposed on a first side of the single layer of substrate;
a sense electrode disposed on the first side of the single layer substrate; and
a display screen, wherein the first side of the single layer of substrate is disposed against a bottom surface of the display screen.

10. The single-layer touchpad as defined in claim 9 wherein the single-layer touchpad is further comprised of a liquid crystal display disposed against a second side of the single-layer substrate.

11. A single-layer touchpad for use with a display screen, said single-layer touchpad comprised of:
a single layer of substrate;
a first electrode disposed on a first side of the single layer of substrate;
a sense electrode disposed on the first side of the single layer substrate; and
a display screen, wherein a second side of the single layer of substrate is disposed against a bottom surface of the display screen.

12. The single-layer touchpad as defined in claim 9 wherein the single-layer touchpad is further comprised of a liquid crystal display disposed against the first side of the single-layer substrate.

13. A single-layer touchpad for use with a display screen, said single-layer touchpad comprised of:
a protective screen over a display;
a first electrode disposed on a first side of the protective screen; and
a sense electrode disposed on the first side of the single layer substrate.

14. A single-layer touchpad for use with a display screen, said single-layer touchpad comprised of:
a display;
a protective screen over the display;
a first electrode disposed between the protective screen and the display; and
a sense electrode disposed between the protective screen and the display.

15. A single-layer touchpad for use with a display screen, said single-layer touchpad comprised of:
a display;
a protective screen over the display;
a single-layer substrate disposed under the display;
a first electrode disposed on the single-layer substrate; and
a sense electrode disposed on the single-layer substrate.

16. A single-layer touchpad for use with a display screen, said single-layer touchpad comprised of:
a display;
a protective screen over the display;
a single-layer substrate disposed under the display;
a first electrode disposed between the single-layer substrate and the display; and
a sense electrode disposed between the single-layer substrate and the display.
